(19) United States
(12) Patent Application Publication
(10) Pub. No.: US 2011/0318700 A1
(43) Pub. Date: Dec. 29, 2011

(54) Method and Apparatus for Dental Thermal Sensitivity Tester

(76) Inventor: Mark A Stepovich, San Jose, CA (US)

(21) Appl. No.: 12/483,721

(22) Filed: Jun. 12, 2009

(51) Int. Cl. A61C 3/00; A61C 19/00

(52) U.S. Cl. 433/27; 433/32

(57) ABSTRACT

A method and apparatus for a dental thermal sensitivity tester have been disclosed. A dental wand has an end that is positionable against a dental feature and has a thermal generation unit in thermal communication with the dental wand end.

### FIELD OF THE INVENTION

The present invention pertains to a dental method and apparatus. More particularly, the present invention relates to a method and apparatus for a dental thermal sensitivity tester.

### BACKGROUND OF THE INVENTION

Dental thermal sensitivity is a source of great pain for many people. It is estimated that 10 million people in the United States are chronically affected with teeth sensitive to hot and/or cold. In Europe the estimate is as high as 45% affected (Cosmetics International Cosmetic Products Report Article, Jan. 1, 2007).

Current approaches to testing for sensitivity are crude at best. One approach is to use a flame to heat a material and then place it into the mouth on a tooth. If the tooth is not sensitive then the patient remains in the dental chair, however, if the tooth is sensitive the patient is likely to suffer excruciating pain and violently move thus possibly injuring themselves. This may present a problem. Using a hot or cold fluid is an all or nothing proposition and again is likely to lead to pain for the patient and it is difficult to determine which particular tooth is sensitive. This presents a problem. Additionally, the current approaches do not give an indication as to how sensitive a tooth might be, simply that it is sensitive. This presents a problem.

### BRIEF DESCRIPTION OF THE DRAWINGS

The invention is illustrated by way of example and not limitation in the figures of the accompanying drawings in which:

FIG. 1 illustrates a network environment in which the method and apparatus of the invention may be implemented;

FIG. 2 is a block diagram of a computer system which may be used in some embodiments of the invention;

FIG. 3 illustrates one embodiment of the present invention showing a dental test probe in several positions;

FIG. 4 illustrates one embodiment of the present invention showing a light source;

FIG. 5 illustrates one embodiment of the present invention showing a light conducting medium;

FIG. 6 illustrates one embodiment of the present invention showing a heat source and a temperature sensor (probe);

FIG. 7 illustrates one embodiment of the invention showing a heating and cooling source;

FIG. 8 illustrates one embodiment of the invention showing a dental probe having two ends;

FIG. 9 illustrates one embodiment of the invention showing a dental probe using fluids;

FIG. 10 illustrates one embodiment of the invention showing a dental probe using fluids and a heatsink with fins;

FIG. 11 illustrates one embodiment of the invention showing a dental probe using a thermally conductive compressible mass; and

FIG. 12 illustrates one embodiment of the invention in flowchart form.

### DETAILED DESCRIPTION

In one embodiment of the present invention a light source (e.g. adjustable) is used to test the sensitivity of teeth.

In one embodiment of the present invention a heat source (e.g. electrical heater element) is used to test the sensitivity of teeth.

In one embodiment of the present invention a cool source (e.g. thermoelectric element) is used to test the sensitivity of teeth.

In one embodiment of the present invention a fluid source (e.g. a heated or cooled liquid) is used to test the sensitivity of teeth.

In one embodiment of the present invention a gas source (e.g. a heated or cooled gas) is used to test the sensitivity of teeth.

In one embodiment, the invention may be used for measuring the sensitivity of a patient's teeth to both hot and cold and a record of this can be recorded for comparison at another time. In this way a change in status may be determined and actions based on such may be taken.

In one embodiment, the invention may be used for measuring the sensitivity of a patient's teeth to both hot and cold and to each other and to the degree to which a sensitive tooth and surrounding teeth are sensitive both before and after treatment. This provides reliable data on efficacy.

In one embodiment, the temperature of the tester (hot or cold) may be slowly adjusted allowing for a measurement of degree of tooth sensitivity without inducing great patient pain due to a large temperature difference.

In one embodiment, the temperature of the tester (hot or cold) may be set to a variety of pre-specified temperatures for measuring tooth sensitivity.

While the above descriptions have illustrated the use of the invention with respect to “teeth” it is to be understood that sensitive teeth can be the result of a variety of conditions, for example pulp conditions, and the invention may be used to test for pulp sensitivity as well as other conditions.

In one embodiment, the temperature of the tester (hot or cold) may be preset to a variety of selected temperatures and the time duration for the temperatures. That is the dental tester (e.g. tooth or pulp) heats or cools to a temperature for a given time and then returns to room temperature. In this manner dental pulp damage may be mitigated.

In one embodiment, the invention may be used to apply heat or cold to other than just teeth or the pulp. That is it may be used as a source of hot or cold for such things as dental mixtures, etc.

In one embodiment of the invention, a tester probe has attached a flexible cup that assists in directing the temperature to a selected region.

In one embodiment of the invention, a tester probe has attached a flexible cup that can hold a thermally conductive material that assists in directing the temperature to a selected region (e.g. making more intimate thermal contact with a tooth, pulp, etc.).

In one embodiment of the invention, a tester probe has attached a flexible cup that has a reflective surface that assists in directing light from a probe end to a selected region (e.g. tooth, gum, etc.).

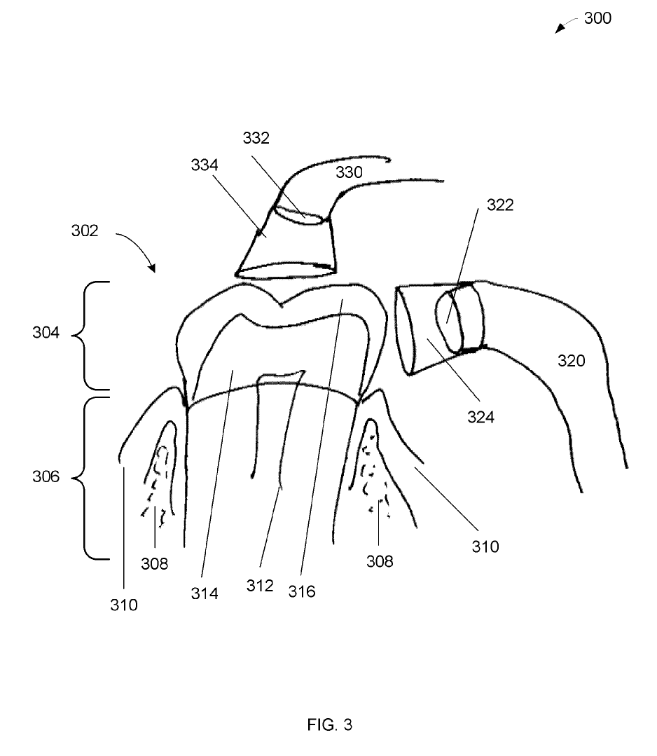

FIG. 3 illustrates, generally at 300, one embodiment of the present invention. At 302 is a tooth having a crown region 304 and a root region 306. At 308 is bone, at 310 is gum, at 312 pulp, 314 dentin, and 316 enamel. At 320 is a tester wand that curves to a termination 322 (end). At 324 is a cup (e.g. flexible) which is attached to the wand 320 near the end 322. The cup 324 when pressed against a dental feature (e.g. enamel, gum, etc.) allows for more intimate connection of the wand end 322 and the dental feature. The cup 324 may also be filled with a thermally conductive material (e.g. paste) to help conduction between the dental feature and wand end 322. At 330 is a wand which is approaching the tooth from the top and has an end 332 and a cup 334.

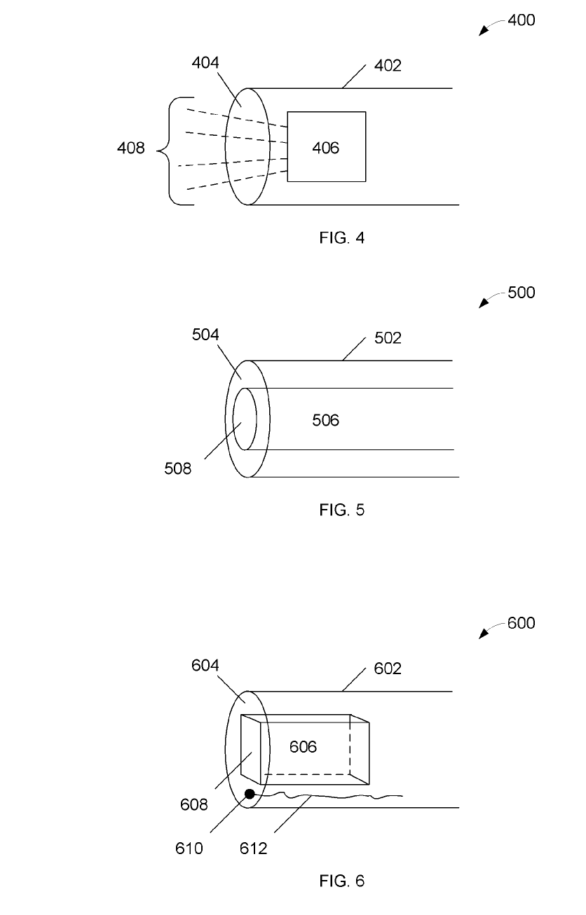

FIG. 4 illustrates, generally at 400, one embodiment of the present invention. At 402 is a testing probe having an end 404 which would come in thermal contact with a surface to be heated. At 406 is a light source (e.g. high power LED) emitting light 408. The light source may be preprogrammed or adjusted for a specific energy and/or heat output.

FIG. 5 illustrates, generally at 500, one embodiment of the present invention. At 502 is testing probe having an end 504 which would come in thermal contact with a surface to be heated. At 506 is a light conducting medium (e.g. fiber optic cable) which is emitting light from end 508. The light source for the light conducting medium 506 may be remotely located at the testing probe other end (not in diagram). The light output may be adjusted for an energy output (e.g. wavelength) and duration.

FIG. 6 illustrates, generally at 600, one embodiment of the present invention. At 602 is testing probe having an end 604 which would come in thermal contact with a surface to be heated. At 606 is a heating element (e.g. electrical resistive heater) which generates heat that will conduct via surface 608 to the testing probe end 604. The heat output may be controlled by a computer specially programmed for control and to display to the user both heat output from 606 and a temperature from a temperature sensor 610 (e.g. thermocouple) (610 probe tip, 612 wire back to computer (not shown in FIG. 6).

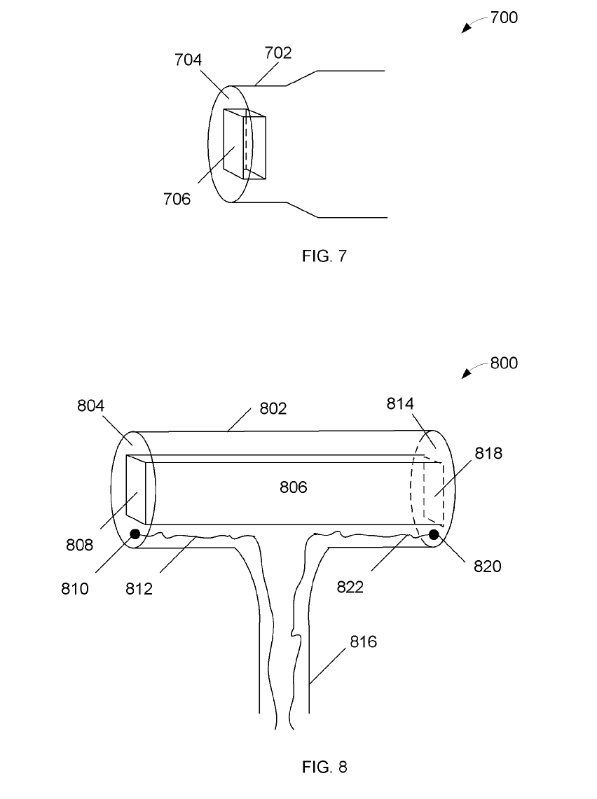

FIG. 7 illustrates, generally at 700, one embodiment of the present invention. At 702 is a dental probe having an end 704 which will come in thermal contact with a dental feature to be heated. At 706 is a heating element and/or cooling element (e.g. thermoelectric element) which generates heat/cooling which will conduct via surface 704 to the dental feature to be heated/cooled. For example, there may be a thermally conductive gel within the dental probe 702 between element 706 and a closed end at 704. There may also be a conductive material between the end 704 and for example, a patient's gum. The heat/cooling output may be controlled by a computer specially programmed for control of voltage polarity to the element 706 as well as current to the element 706 and the timing of both voltage and current and polarity to the element 706. In this way, for example, the probe end 704 may be heated and cooled rapidly to create a desired time-temperature profile rather than simply heating and letting the probe cool on its own to ambient temperature, or simply cooling the probe and letting the probe warm on its own to ambient temperature.

FIG. 8 illustrates, generally at 800, one embodiment of the present invention. At 802 is a dental probe having two ends 804 and 814 and a handle 816 near the middle. For example, the dental probe 802 may have a hot end 804 which will come in thermal contact with a surface to be heated and a cold end 814 which will come in thermal contact with a surface to be cooled. In this way the user may quickly rotate the dental probe 802 to either heat or cool a surface. Each temperature may be independently controlled and measured. At 806 is a heating and cooling assembly (e.g. one or more thermoelectric devices) having ends 808 and 818. Also shown are temperature sensors 810 (e.g. thermistor) and wires 812, and sensor 820 and wires 822.

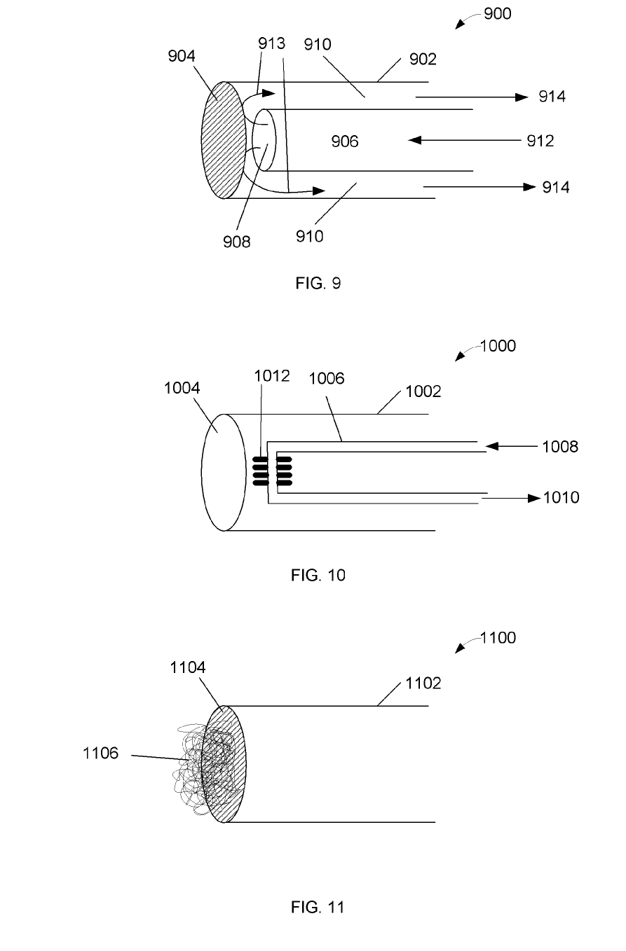

FIG. 9 illustrates, generally at 900, one embodiment of the present invention. At 902 is a dental probe having an interior gas or fluid communicating tube 906. Tube 906 is capable of conveying fluids, liquids or gases, or a combination of liquid and gas from a distal end (not shown in FIG. 9) through the path noted at 912 and then transfers heat or cold to the sealed surface 904 (shaded here in FIG. 9 for sake of clarity) of dental probe 902 when the flow from 912 impinges on the surface 904 and changes direction as noted at 913 and is returned to the distal end via pathways 910 in the direction indicated by 914. In this way a fluid such as a liquid or gas or combination of liquid and gas may be used to apply a temperature from surface 904 to a dental feature. Optionally (not shown) a temperature sensor may be placed in thermal communication with surface 904 to provide readings of the temperature of surface 904. As illustrated (one end only) in FIG. 9 in one embodiment the fluid, gases or liquids or a combination of gas and liquids would recirculate in a sealed environment so that no new fluid, gases or liquids or a combination of gas and liquid need be added to the dental probe 902.

FIG. 10 illustrates, generally at 1000, one embodiment of the present invention. At 1002 is a dental probe having an interior gas or fluid communicating tube 1006. Tube 1006 is capable of conveying fluids, liquids or gases, or a combination of liquid and gas from a distal end (not shown in FIG. 10) through the path noted at 1008 and then transfers heat or cold to the heatsink fins 1012 which then transfer the heat or cold to the end of probe surface 1004 before returning via path as indicated at 1010. Between the fins 1012 and surface 1004 may be a thermal conductor (e.g. solid metal, a paste, a gel, mica, diamond, thermal grease, heat pipe, etc.).

Various embodiments as illustrated have shown a flat surface for contact with a dental feature, however the invention is not so limited, and other regular and irregular shapes may be used. Additionally, the probe end may be of a malleable or deformable or compressible material that may be shaped by pressing against a dental feature, for example, the crown of a tooth. For example, a tangle of loosely bound metal fibers (much like steel wool) attached to the probe may be used to provide a more satisfactory thermal contact.

FIG. 11 illustrates, generally at 1100, one embodiment of the present invention. At 1102 is a dental tester having an end surface 1104 which is in contact with a thermally conductive compressible mass 1106. When 1106 is pressed against a dental feature, for example, a crown it will deform and make thermally intimate contact with the crown. Mass 1106 may be permanently or disposably attached to surface 1104 (e.g. glue, clip, magnetic, etc.).

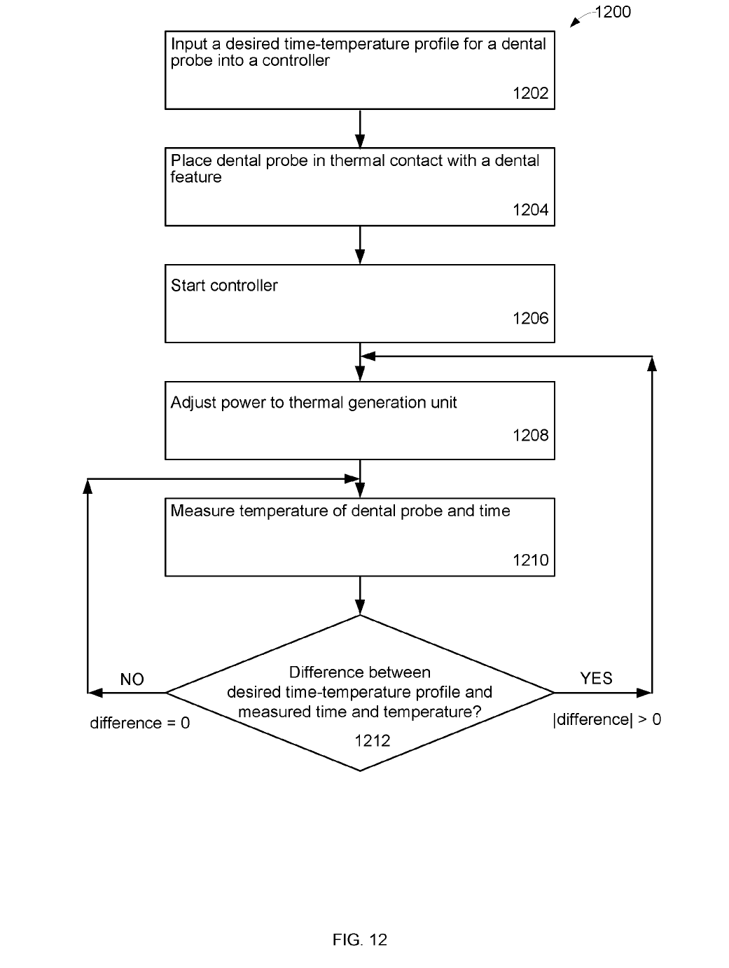

FIG. 12 illustrates, generally at 1200, one embodiment of the present invention in flowchart form. At 1202 a desired time-temperature profile for a dental probe is entered into a controller. For example, using a computer with a keyboard and mouse to specify the time and temperature points, or a slope and end points, or a steady-state temperature, or a spreadsheet input of time and temperature, etc. and using a computer program to control electronics for a controller. At 1204 the user places the dental probe in thermal contact with a dental feature. For example, a gum, a crown, a filling, etc. At 1206 the controller is started. For example, starting a computer specifically programmed to transform the inputted desired time-temperature profile into a set of electrical signals that transform into a temperature at the dental probe end. At 1208 adjusting the power to the thermal generation unit. For example, running a computer specifically programmed to adjust electrical signals that transform into adjusting power (e.g. triac). At 1210 measuring the temperature of the dental probe and the time. For example, running a computer specifically programmed to input signals from a temperature sensor and transform them into a temperature reading (e.g. thermistor, analog to digital converter, lookup table) and a computer specifically programmed to record accurate time of measurement (e.g. counting clock pulses from a crystal oscillator accurately calibrated to, for example, an atomic clock, and transforming the clock pulses into a real time). At 1212 determining if there is a difference between the desired time-temperature profile and the measured time and temperature and if so then adjusting power to the thermal generation unit 1208 and if not then measuring the temperature of the dental probe and the time 1210. If the difference is zero then NO path to 1210 is taken. If there is a difference (|difference|>0) the YES path to 1208 is taken. That is, the thermal generation unit is only adjusted if there is a measurable difference between the desired time-temperature profile and the measured time-temperature profile. For example, running a computer specifically programmed to determine the difference between the desired temperature and the measured temperature and transforming this difference into a yes or no result, and for example, running a computer specifically programmed to determine the difference between the desired time and the measured time and transforming this difference into a yes or no result, and for example, running a computer specifically programmed to input the temperature yes/no result and the time yes/no result and transform this into a YES (to 1208) or NO (to 1210) to determine the course of action for the controller.

Control of a heating or cooling or heating and cooling unit may be performed by utilizing for example electrical methods. For example modulation of voltage or current or voltage and current may be used. Modulation methods of amplitude, frequency, pulse position, pulse width, pulsing, bang-bang (on-off), etc. and any and all combinations may be used. For example, pulse width modulation at a first voltage may be used and if higher output is needed then pulse width modulation at a second voltage higher than the first voltage. Additionally, alternating current (AC) or direct current (DC) or a combination of AC and DC may be used for electrical control.

Various embodiments as illustrated have shown a flat surface for contact with a dental feature and a roundish body, however the invention is not so limited, and other regular and irregular shapes may be used. For example a contoured body may be used as well as a deformable body such as a goose-neck type device so that a user may bend the dental tester to better reach a dental feature. Additionally, while no mention has been made of the materials to be used, one of skill in the art will appreciate that a thermally insulating layer for a tester body is advisable if limiting the heat transfer through the tester body (to for example the user and/or other dental features). Likewise if using an electrical thermal unit, proper electrical insulation is wise.

In one embodiment of the invention the time-temperature profile is used to establish measurements of sensitivity. For maximum responsiveness and quick temperature response times it is necessary to minimize thermal mass and actively heat and cool. To minimize thermal mass, in one embodiment of the invention, the heating/cooling element is placed directly at the end of the probe. For quick response the heating/cooling element is rapidly driven and a feedback mechanism is used to prevent overshoot. For example, a rapid rise in temperature may be achieved by driving at a high current a thermoelectric device. To prevent overshoot as the temperature approaches the pre-specified limit the polarity may be reversed and a current enabling cooling is applied. Additionally, characterizing the dental probers thermal characteristics allows for computer driven modeling and predictive behavior. For example, measuring and then knowing the thermal mass and thermal resistance when programmed into a specially designed computer program can allow for transforming the data into predictive responses. These can then be measured against actual response (via temperature sensor at end of dental probe) and in this way the unknown thermal characteristics of the dental feature in contact with the dental probe can be estimated and using a specially designed computer program can allow for transforming the data into updated driving characteristics for the dental probe to more nearly attain a desired time-temperature response curve for the fully loaded system (i.e. dental probe in contact with dental feature). This approach is especially useful where the thermal characteristics of the dental features vary. For example, crown versus gum, or a dental probe having a cup filled with thermally conductive material then in contact with a dental feature, etc.

Additionally the dental probe may be used to measure temperature of dental features and to determine the thermal characteristics of dental features. For example a crown may be heated or cooled to a temperature by the dental probe and then the heating/cooling turned off and the temperature decline of the crown may be recorded. This data may be used for recording and diagnosis.

What is to be appreciated is that the dental probe may be used, for among other things, to determine dental feature temperature sensitivity, dental feature temperature responsiveness, dental feature thermal characteristics, etc. These may be used for baseline analysis, trends, diagnosis, characterization, detecting changes, etc.

Thus a method and apparatus for a dental thermal sensitivity tester have been described.

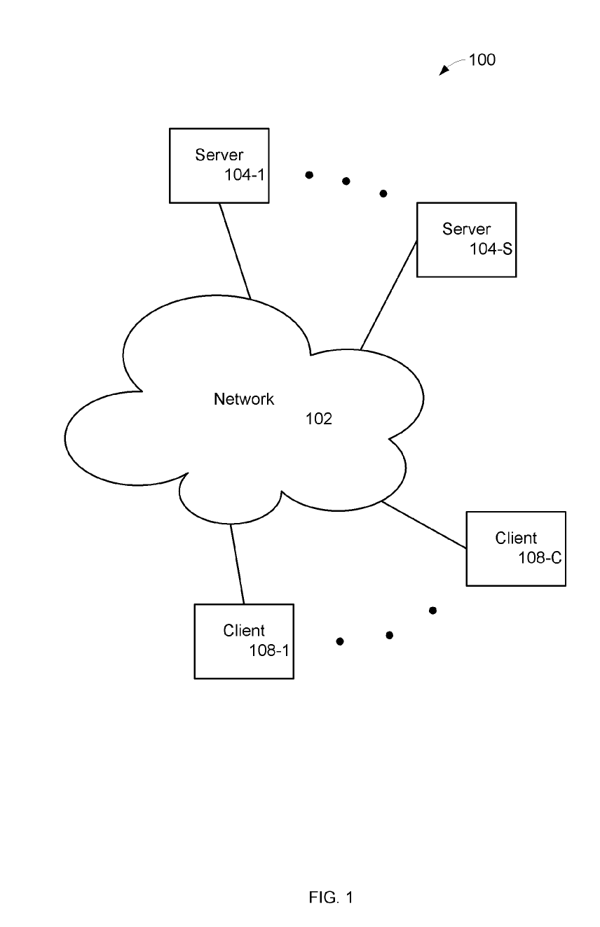

FIG. 1 illustrates a network environment 100 in which the techniques described may be applied. The network environment 100 has a network 102 that connects S servers 104-1 through 104-S, and C clients 108-1 through 108-C. More details are described below.

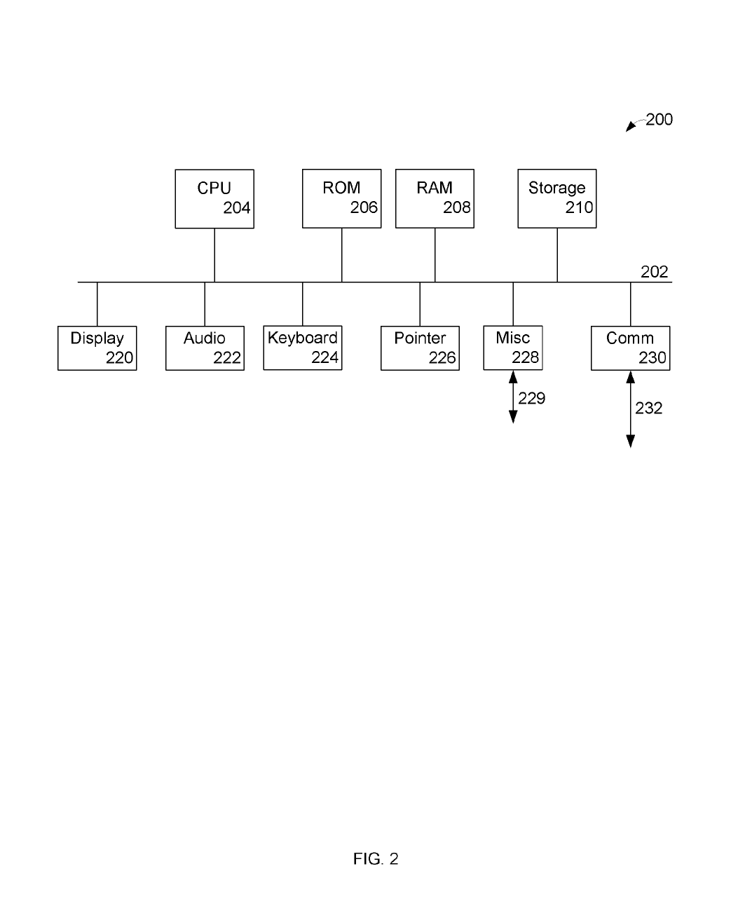

FIG. 2 is a block diagram of a computer system 200 which some embodiments of the invention may use and which may be representative of use in any of the clients and/or servers shown in FIG. 1, as well as, devices, clients, and servers in other Figures. More details are described below.

Referring back to FIG. 1, FIG. 1 illustrates a network environment 100 in which the techniques described may be applied. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to any type of electronic device. Thus, for example, the invention may find application at both the S servers 104-1 through 104-S, and C clients 108-1 through 108-C.

Further the method and apparatus described herein may be available and/or capabilities based on a variety of criteria. For example, certain features may be based upon communication of a payment and/or credit.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228, I/O links 229, communications 230, and communication links 232. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, an embodiment of the present invention. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those of skill in the art to describe techniques and approaches. Furthermore, in the description, for purposes of explanation, numerous specific details are set forth in order to provide a thorough understanding of the present invention. It will be evident, however, to one of skill in the art that the present invention may be practiced without these specific details. In some instances, well-known structures and devices are shown in block diagram form, rather than in detail, in order to avoid obscuring the present invention. These embodiments are described in sufficient detail to enable those of skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory, and/or logic circuitry. These algorithmic descriptions and representations are the means used by those of skill in the arts to most effectively convey the substance of their work to others of skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Further, any of the methods according to the present invention can be implemented in hard-wired circuitry, by programmable logic, or by any combination of hardware and software.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk- read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ) as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.) capable of affecting a physical entity (e.g. movement) upon absorption and/or reflection of such; etc.

Embodiments of the present invention produce a useful, concrete, and tangible result, for example, but not limited to, a physical transformation in a device, a memory, or storage device, a real world display of results to a user, etc. For example, one or more embodiments of the present invention alter the contents of a device which may be in the form of a physical electrical charge on the device resulting from the tangible number of electrons and the contents of the device may be presented to a user in a real world display, such as, but not limited to, a screen, etc.

As used in this description, “dental features” or “dental surface” or “dental structure” or similar phrases means any structure or surface found in the mouth, for example, but not limited to, gum, pulp, tongue, teeth, crown, dentine, root canal of a tooth, enamel, pulp chamber, ligament, bone, etc. Additionally “dental features” or “dental surface” or “dental structure” or similar phrases means any dental device or dental substance that may be found in the mouth, for example, but not limited to, braces, temporary fillings, fillings, molds, ceramics, bridges, dental implants, molding material, filling material, etc.

As used in this description, “thermoelectric elements” or “thermoelectric device” or “thermoelectric module” or similar phrases means any structure or device using the Seeback and/or Peltier Effect and/or Thomson effect and/or thermoelectric effect to generate a voltage and/or generate a temperature differential. A thermoelectric device may be used for heating and cooling, measuring temperature, generating electricity, and the heating and cooling are determined by the polarity of an applied voltage. One of skill in the art will appreciate that properly applied voltages and current and polarity will allow a time-temperature profile both above and below ambient temperature.

As used in this description, “fluid” or similar phrases means a gas or a liquid or a solid or any combination of gas, liquid, and solid that can flow. For example, one fluid may be combination of liquid with suspended solids (e.g. slurry). Another example of a fluid may be a combination of a gas and a liquid.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus a method and apparatus for a dental thermal sensitivity tester have been described.

What is claimed is:

1. An apparatus comprising:
a dental wand having a body and a first end wherein said first end is positionable against a dental feature; and
a thermal generation unit in thermal communication with said dental wand first end.

2. The apparatus of claim 1 further comprising an open-ended cup-like structure attached to said dental wand first end.

3. The apparatus of claim 2 wherein said open-ended cup-like structure holds a thermally conductive material for conducting from said dental wand first end.

4. The apparatus of claim 1 wherein said thermal generation unit is located within said dental wand body proximate to said dental wand first end.

5. The apparatus of claim 4 wherein said thermal generation unit generates heat relative to ambient conditions.

6. The apparatus of claim 4 wherein said thermal generation unit generates cold relative to ambient conditions.

7. The apparatus of claim 4 wherein said thermal generation unit generates heat and cold relative to ambient conditions.

8. The apparatus of claim 4 wherein said thermal generation unit is an entity selected from the group consisting of a light emitting diode, a laser, a radio-frequency unit, an electrical heating element, a thermoelectric device, a heated gas, a heated liquid, a heated gas and liquid combination, a cooled gas, a cooled liquid, a cooled gas and liquid combination, and a high intensity light source and optical fiber.

9. The apparatus of claim 1 wherein said thermal generation unit is a heatsink structure located proximate to said dental wand first end, and wherein said heat-sink structure is in communication with a thermal source selected from the group consisting of a recirculating heated gas, a recirculating heated liquid, a recirculating heated gas and liquid combination, a recirculating cooled gas, a recirculating cooled liquid, a recirculating cooled gas and liquid combination, and a high intensity light source and optical fiber.

10. An apparatus comprising:
a dental tester having a first end and a second end and a handle;
a thermal generating unit having a first end and a second end, said thermal generating unit first end in thermal communication with said dental tester first end, said thermal generating unit second end in thermal communication with said dental tester second end;
a first temperature sensor, said first temperature sensor in thermal communication with said dental tester first end; and
a second temperature sensor, said second temperature sensor in thermal communication with said dental tester second end.

11. The apparatus of claim 10 further comprising:
a first deformable thermally conductive mass, said first deformable thermally conductive mass in thermal communication with said dental tester first end; and
a second deformable thermally conductive mass, said second deformable thermally conductive mass in thermal communication with said dental tester second end.

12. The apparatus of claim 10 further comprising a thermal assembly, said thermal assembly having a first end and a second end; and wherein said thermal assembly first end is in thermal communication with said dental tester first end, and wherein said thermal assembly second end is in thermal communication with said dental tester second end.

13. The apparatus of claim 12 wherein said thermal assembly is one or more thermoelectric devices.

14. A method comprising:
(a) inputting a desired time-temperature profile for a dental probe into a controller;
(b) starting said controller;
(c) adjusting power to a thermal generation unit;
(d) measuring a temperature of said dental probe;
(e) measuring a time of said measuring said temperature of said dental probe;
(f) determining a difference between said desired time-temperature profile and said measured temperature of said probe and said measured time of said measuring said temperature of said dental probe; and
if said difference is zero then
(g) going to (d);
else
(h) going to (c).
